(19) United States
(12) Patent Application Publication
(10) Pub. No.: US 2008/0205573 A1
(43) Pub. Date: Aug. 28, 2008

(54) Cellular, Electron Cooled Storage Ring System and Method for Fusion Power Generation

(76) Inventor: Delbert J. Larson, Waxahachie, TX (US)

Correspondence Address: WILSON DANIEL SWAYZE, JR., 3804 CLEARWATER CT., PLANO, TX, 75025, US

(21) Appl. No.: 11/678,586

(22) Filed: Feb. 24, 2007

(51) Int. Cl. G21B 1/00

(52) U.S. Cl. 376/107

(57) ABSTRACT

A cellular electron cooled storage ring system and method for achieving particle-fusion based energy, including a vacuum chamber to allow electron beam and ion beam merging and separation, cathodes to generate the electron beams, collectors to collect the electron beams, and magnetic field generation devices to guide the electrons and ions on their desired trajectories as well as contain neutralizing particles. By overlapping the electron and ion beams, thermal energy is transferred from the ion beams to the electron beams, which allows the invention to overcome particle losses due to resonances, scattering and heating of the ion beams. Advantageously, ions are accelerated to an energy that is near optimum for fusion reactions to occur, and uses electron energies that maintain this advantageous situation. Advantageously, the recirculation of ions that do not fuse or scatter at too large of an angle is allowed, giving such ions additional chances to participate in a desired fusion reaction. Advantageously, the invention allows for a continual addition of new ions to be added to the circulating ions already in the system. This combination of advantages results in a significant improvement in the predicted output power to input power ratio over previous particle fusion technologies.

### FIELD OF THE INVENTION

The present invention relates to a device intended to induce particle beam collisions for the purpose of creating usable electrical energy, more particularly, to a method and system that achieves extremely high density, low energy ion beams by overlapping the beams with a properly formed electron beam, and furthermore, guides and focuses the ion beams into collision with each other within a very small collision area. Each of the colliding beams is contained in its own storage ring, with electron cooling sections on opposing sides of the ring. Each storage ring also has one or more sections that overlap a section from an adjacent storage ring, and it is in these overlapping sections that the beams are brought into collision and fusion energy is released.

### BACKGROUND OF THE INVENTION

It has been known for decades that the power generated by the stars, including our own sun, comes from a chain of nuclear reactions that fuse hydrogen into heavier elements. One reaction in particular which has been of great interest is

D+T->He⁴+n+17.6 MeV. (1)

The reaction of Eq. (1) has a very high probability of occurrence, with a cross section reaching about 5 barns at a center of mass energy of about 100 keV. The output energy of the reaction of Eq. (1) is about ten million times the output energy of typical chemical reactions. The fuel sources for the reaction of Eq. (1) are isotopes of hydrogen. One of the isotopes, deuterium (D), is readily available in enormous quantities in sea water, and the other, tritium (T), can be generated by placing Lithium blankets around a fusion device. The neutron (n) generated in Eq. (1) can react with the Lithium (Li) through the reaction

n+Li⁶->T+He⁴+4.8 MeV. (2)

The reaction of Eq. (2) allows even more energy to be generated from the fusion reaction as well as generating more fuel for the reaction of Eq. (1). The end products of the reactions (1) and (2) are two Helium nuclei (He). Thus the fusion reactions result in reaction products that are not themselves radioactive, leading to the expectation that fusion energy generation will be clean—there will be no radioactive waste, no biological waste, and no green house gas waste directly produced from the reactions in Eqs. (1) and (2). (Of course, considerable activation of surrounding materials can occur for those neutrons that do not interact via Eq. (2).)

Leading existing schemes for attempting to induce useful levels of fusion energy involve tokamaks and inertial confinement devices. Tokamaks work by heating a plasma of ions and electrons to a level where some of the ions will undergo fusion, while inertial confinement devices impinge beams of either particles or photons (light) upon a small target of fusable materials. In both of these conventional techniques, the ions have random velocity directions and magnitudes and only a small fraction of the ion pairs have the optimum conditions for a fusion event to occur.

In addition to tokamaks and inertial confinement devices, numerous other approaches to fusion have been attempted as well. Muon induced fusion involves the use of muons to form atomic states of deuterium bound to tritium wherein the bound molecule is so tightly bound that fusion occurs. Cold fusion experiments were done with electrolysis of deuterated water, with some evidence of fusion occurring within the cells. Sonic wave induction of imploding bubbles in deuterated water is also being investigated.

But despite all of the many and diverse efforts to date, no fusion energy production system has come close to the goal of serving as a useful source for electric energy. Accordingly, there is a need for an improved method and system for generating fusion energy.

### SUMMARY OF THE INVENTION

The present invention, which addresses the above desires and provides various advantages, resides in a method and system for generating kilowatt levels of output fusion energy. The system includes particle supplies for generating beams of projectile or reaction particles, overlapping storage rings for containing and recycling the projectile particles, electron cooling systems for stabilizing and restoring energy to the projectile particles, and interaction regions where the storage rings overlap for initiating nuclear fusion reactions with the projectile particles to generate the desired energy source. The system also includes a plurality of dipoles, quadrupoles, torroids and solenoids selectively situated around the rings to “bend” the direction of travel of the projectile particles within the system as well as to focus the beams down to a small size when they come into collision.

By providing closed storage rings, the particle beams are contained within the system to repeatedly recirculate inside the storage rings. Particles that do not undergo fusion or are scattered at too large of an angle are given another chance to fuse every time they circulate within the system. And, as the particle supplies continuously inject low currents of additional particles into the storage rings which merge with previously injected particles circulating in the rings, relatively high intensity beams develop and are effectively stored in the system, even though the input currents used to populate the system remains relatively low throughout the operation of the system. While a small fraction of particles is lost to fusion reactions, scattering, recombination and charge exchange, the particle beams eventually increase in intensity as they circulate the ring, until equilibrium is reached between the additional currents injected into the system and the currents lost to fusion reactions, scattering, recombination and charge exchange.

Distinctly, the present invention effectively retains and conserves the energy introduced into the system by recycling and reusing the reaction particles. In particular, the bulk of the energy expended in the initial provision of the particle beams is not dissipated as excess heat, but retained in the particle beams as the projectile particles are enabled for repeated encounters with each other with each revolution.

Because the projectile particles are permitted to circulate in the system, instabilities could build up in the particle beams due to particle-particle interactions or particle-electromagnetic-field interactions. Advantageously, the system maintains the particle beams within optimal reaction parameters by providing the electron cooling systems to stabilize or “cool” the particle beams. Without the electron cooling systems, the particle beams would develop internal trajectories that would cause such a significant loss of beam particles that the device would not produce useful energy.

The electron cooling systems include electron injectors which inject electron beams into the storage rings, into the path of the particle beams, and electron capture devices which capture the electron beams. The electrons are injected with a predetermined amount of energy to cause the projectile particles to move at an ideal velocity. By traveling and interacting with the particle beams, the electron beams maintain the particle beams within parameters that optimize fusion energy production. Any heating, scattering and deceleration that would otherwise adversely affect the particles stored in the system are effectively compensated for by the electron beams. Accordingly, scattering and energy loss in the beams is substantially continuously compensated for before significant instabilities have an opportunity to develop. In this manner, events that would typically cause significant instabilities in the particle beams are minimized if not eliminated.

In order for the invention to produce useful levels of output power it is important that the colliding particle beams be focused onto a small spot. Advantageously, the invention uses magnetic solenoids and quadrupoles that are arranged to have fields which, in concert with the magnetic dipoles and drift lengths, focus the particle beams into a very small size at the point they are passing by each other. By arranging for the high intensity and very small size at the collision region, useful levels of fusion output energy are generated.

As a result of the small spot size “beam halo” is formed in the particle beams. Beam halo is a significant but minority portion of the beam that has different characteristics than does the majority portion of the beam. Due to its different characteristics, particles contained within the beam halo would be lost from the system if no means is supplied to prevent that from happening. Advantageously, the invention employs magnetic devices placed where the majority beam is smallest in order to separately affect the beam halo trajectories. Magnetic focusing devices more strongly affect particles farther from the beam axis than they do particles close to the beam axis. By placing such focusing devices at places where the majority beam is much smaller than the beam halo, the invention advantageously is able to significantly reduce particle losses due to beam halo formation.

High intensity particle beams generate significant levels of electromagnetic fields due to the particle's electric charge and motion. Background particles formed from the ionization of the residual gas in the system will neutralize most of the electric fields present in the system. (The electric fields that remain will be found near the outer portion of the beams; it is these fields along with some strong scattering events that cause the beam halo to form.) In the region where the particle beams overlap the magnetic fields of the two beams cancel. (This is true both for the region where the ion beams overlap and for the region where the electron and ion beams overlap.) However, in the transport regions where there is no beam overlap, significant magnetic fields due to the particle beam's electric charge and motion will remain. Advantageously, the invention places magnetic focusing devices at the correct placement and with the correct field strength so as to recirculate the beam particles in the presence of the self field forces. The invention also uses tunable magnetic focusing devices so that changes in operational characteristics (during device turn on, for instance) can be handled by the beam optics of the device.

Other features and advantages of the present invention will become apparent from the following detailed description of the preferred embodiments, taken in conjunction with the accompanying drawings, which illustrate by way of example the principles of the invention.

### BRIEF DESCRIPTION OF THE DRAWINGS

The invention is explained in more detail below with reference to the accompanying drawings in which:

FIG. 1 is a schematic view of a system employing two electron-cooled intersecting storage rings for use in the invention and depicts particle beam positions within the invention;

FIG. 2 is a schematic view of a system employing three electron-cooled intersecting storage rings for use in the invention and depicts particle beam positions within the invention;

FIG. 3 is a schematic view of a system employing two electron-cooled intersecting storage rings for use in the invention to depict the placement of the subcomponents;

FIG. 4 is a schematic view of a system employing three electron-cooled intersecting storage rings for use in the invention to depict the placement of the subcomponents;

FIG. 5 is a schematic view of the ion injection and electron cooling system employed as part of the intersecting storage rings shown in FIG. 1, FIG. 2, FIG. 3 and FIG. 4;

FIG. 6 is a schematic view of the electron cooling system that have no ion source which are employed as part of the intersecting storage rings shown in FIG. 1, FIG. 2, FIG. 3 and FIG. 4;

FIG. 7 is a schematic view of the left end transport system of the intersecting storage rings shown in FIG. 1, FIG. 2, FIG. 3 and FIG. 4;

FIG. 8 is a schematic view of the right end transport system of the intersecting storage rings shown in FIG. 1, FIG. 2, FIG. 3 and FIG. 4;

FIG. 9 is a schematic view of the interaction transport system of the intersecting storage rings shown in FIG. 1, FIG. 2, FIG. 3 and FIG. 4.

### DESCRIPTION OF THE PREFERRED EMBODIMENTS

### Summary Description of Preferred Embodiment Operation

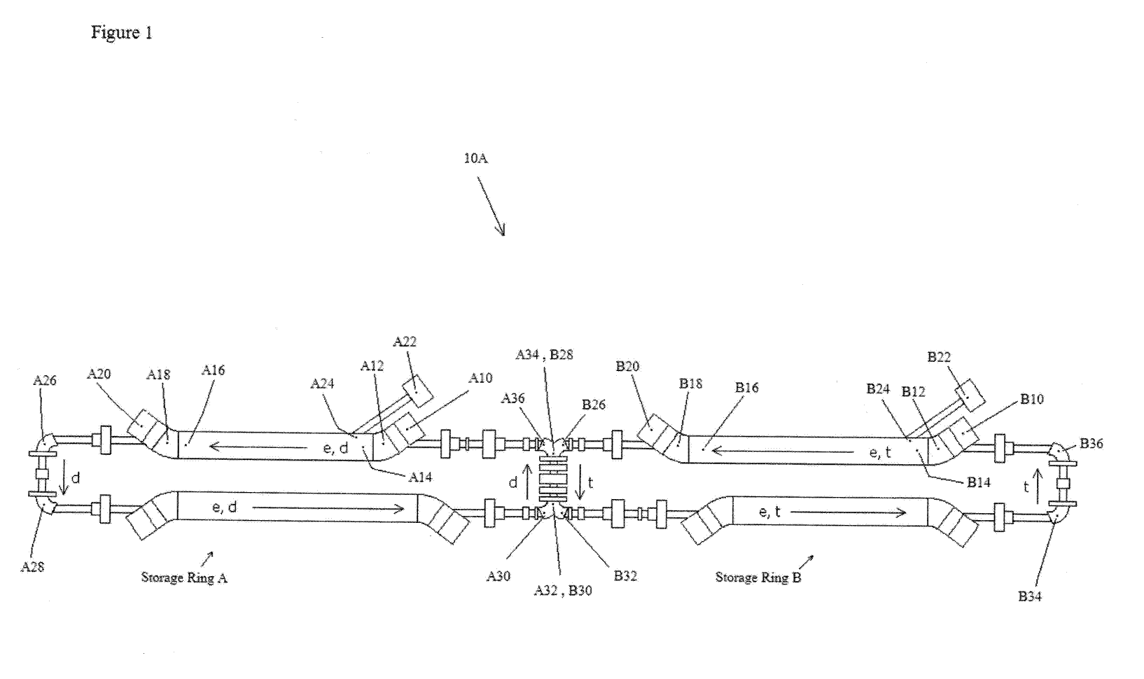

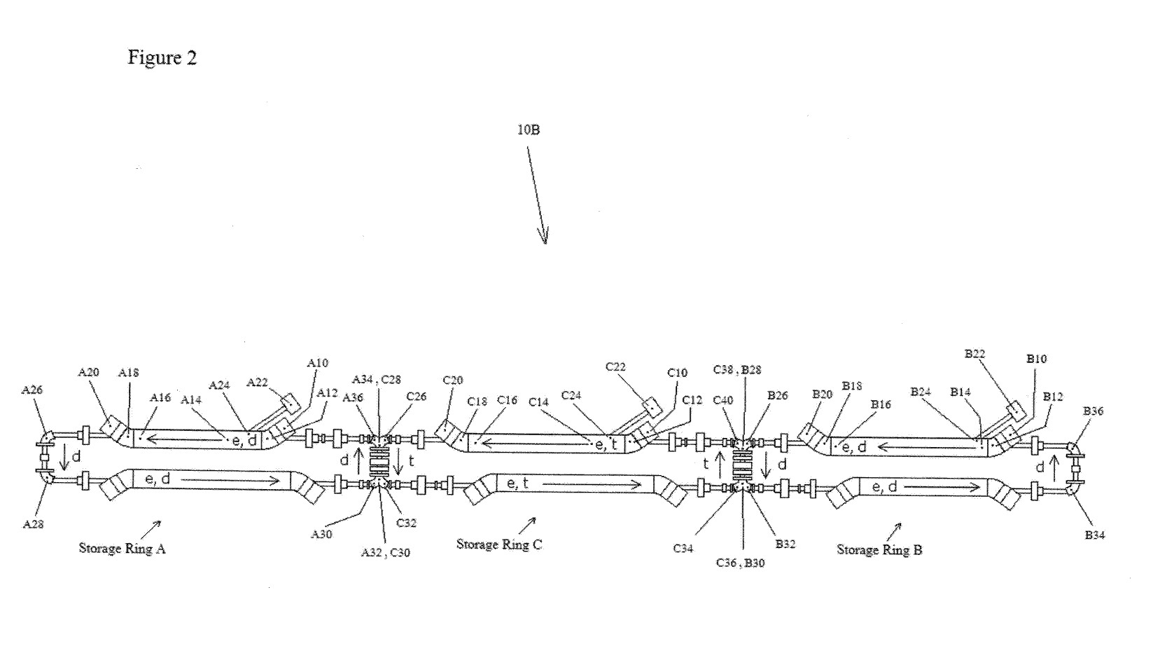

An electron-cooled intersecting storage ring system 10A employing two intersecting storage rings for achieving controlled nuclear fusion and capable of generating useful levels of electric energy is shown in FIG. 1. An electron-cooled intersecting storage ring system 10B employing three intersecting storage rings for achieving controlled nuclear fusion and capable of generating useful levels of electric energy is shown in FIG. 2. Preferred embodiments can contain four, five, or more intersecting storage rings. In a power plant, the number of intersecting storage rings will be quite large. This description of the preferred embodiments will use deuterium and tritium as the example ions, but, as mentioned in the claims, other ions could be used in the invention as well.

The electron-cooled intersecting storage ring system 10 utilizes a combination of elements, including an ion source 20 for supplying ions 22, an electron source 24 for supplying electrons 26, a vacuum chamber 28 for containing particles within a region of low pressure, solenoidal wire windings 30 and torroidal wire windings 32 to provide guiding and containing magnetic fields for electron 26 beam transport, an electron collector 34 to collect the electrons 26 after they have performed their function, solenoid magnets 36 and quadrupole magnets 38 to focus the ions 22 and dipole magnets 40 to bend the ions 22. The ion source 20, electron source 24, vacuum chamber 28, solenoidal wire windings 30, torroidal wire windings 32, electron collector 34, solenoid magnets 36, quadrupole magnets 38 and dipole magnets 40 can be made of off the shelf standard contemporary materials.

The direction of particle motion for an embodiment of the invention using two storage rings is shown in FIG. 1. In the storage ring on the left (denoted as storage ring A) electrons 26 in one electron cooling system 14A leave the electron source 24 near position A10, are guided by fields produced in solenoidal wire windings 30, and further are guided and bent by fields produced in the torroidal wire windings 32 so that they pass near position A12. The electrons 26 are guided then by fields produced in solenoidal wire windings 30 in the long straight section, eventually passing first near position A14 and then near position A16. After passing near position A16 the electrons 26 enter the downstream torroidal region where they are guided and bent by fields produced in the torroidal wire windings 32, passing near position A18, and then are guided by fields produced in solenoidal wire windings 30, with the electrons 26 collected near position A20. The electrons 26 in the system 14B (14B is depicted below the system 14A) follow similar trajectories to the electrons 26 in the system 14A. Deuterium ions 22A are produced in an ion source 20 near position A22 and enter the long straight section of the system 14A at a small angle, where they then merge with the electron 26 beam near position A24. Small angle Coulomb scattering collisions bend the deuterium ions 22A until they are moving substantially in the same direction as the electrons 26 when the deuterium ions 22A pass near position A16. Due to their large mass, the deuterium ions 22A travel nearly straight through the solenoidal wire windings 30 and torroidal wire windings 32, and are then focused by solenoid 36 and quadrupole 38 magnets, and arrive at a dipole 40A. The deuterium ion 22A trajectories are bent in the dipole 40A field, passing near position A26, and are then focused by solenoid 36 and quadrupole 38 magnets until they arrive at a second dipole 40A. The deuterium ion 22A trajectories are bent in the dipole 40A field, passing near position A28 and then exit the dipole 40A and are focused in solenoid 36 and quadrupole 38 magnets, and then pass through solenoidal wire windings 30 and torroidal wire windings 32 of the electron cooling system 14B, are then focused by solenoid 36 and quadrupole 38 magnets, and eventually enter a merging and separating dipole 40B near position A30. The deuterium ion 22A trajectories are bent in the dipole 40B field, and are merged to fully overlap the on-coming tritium ion 22B trajectories near position A32. The deuterium ion 22A trajectories then travel through the interaction region where they are focused tightly into two small regions by solenoids 36. A first overlap section exists between the merging and separating dipole containing positions A30 and A32 and the merging and separating dipole containing positions A34 and A36. It is in the small regions within the first overlap section that the fusion interactions predominantly occur, since the oncoming tritium ions 22B are also focused tightly into these regions and the relative velocities between the deuterium ions 22A and tritium ions 22B are appropriate for fusion to occur. The deuterium ion 22A trajectories then enter a second merging and separating dipole 40B passing near position A34 and are bent and separated from the oncoming tritium ions 22B, with the deuterium ions 22B next passing near position A36. After leaving the merging and separating dipole 40B, the deuterium ions 22A pass through solenoid 36 and quadrupole magnets 38 which focus the beam and then the deuterium ions 22A re-enter the electron cooling system 14A, passing near position A14 and then near position A16. The deuterium ions 22A then continue to cycle around the system from a position near A16 to a position near A26 to a position near A28 to a position near A30 to a position near A32 to a position near A34 to a position near A36 to a position near A14 and back to near the position A16 again.

The tritium ions 22B in FIG. 1 follow trajectories similar to what was just described for the deuterium ions 22A, except that the positions are labeled as B in the figure and the order of traversal of the subcomponents is different. (In A, the deuterium ions 22A traverse an electron cooling system 14A, an end region 16A, an electron cooling system 14B, and an interaction transport system 18. In B, the tritium ions 22B traverse an electron cooling system 14A, an interaction transport system 18, an electron cooling system 14B, and an end region 16B.) The tritium ions 22B in the storage ring B start in the ion source 20 near position B22 and then travel to a position near B24 to near B16 to near B26 to near B28 to near B30 to near B32 to near B34 to near B36 to near B16 again. The tritium ions 22B then continue to cycle around the system from near B16 to near B26 to near B28 to near B30 to near B32 to near B34 to near B36 to near B14 and back to near B16 again. The electrons 26 in the electron cooling system 14A that overlap the tritium ions 22B leave the electron source 24 near position B10, are guided by fields produced in solenoidal wire windings 30, and further are guided and bent by fields produced in the torroidal wire windings 32 so that they pass first near position B12, then near position B14, then near position B16, then near position B18, until they are finally collected then near position B20. The electrons 26 in the system 14B (14B is depicted below the system 14A) follow similar trajectories to the electrons 26 in the system 14A.

FIG. 2 shows positions of particle travel within a preferred embodiment of the invention making use of three intersecting storage rings. In this case, deuterium ions 22A and their associated electrons 26 will follow trajectories A and B as described in the preceding paragraphs, while tritium ions 22B and their associated electrons 26 will follow trajectories C. The storage ring C is slightly different than what has been described above in that it has two interaction transport systems 18, one on each end, rather than one end transport system 16 and one interaction transport system 18 on its ends; a second overlap section exists between the merging and separating dipole that contains the positions C26 and C28 and the merging and separating dipole that contains the positions C30 and C32; a third overlap section exists between the merging and separating dipole that contains the positions C34 and C36 and the merging and separating dipole that contains the positions C38 and C40. But despite this slight difference the transport through its individual components is similar to what has been described above. The tritium ions 22B in the storage ring C start in the ion source 20 near position C22 and then travel to a position near C24 to near C16 to near C26 to near C28 to near C30 to near C32 to near C34 to near C36 to near C38 to near C40 to near C16 again. The tritium ions 22B then continue to cycle around the system from near C16 to near C26 to near C28 to near C30 to near C32 to near C34 to near C36 to near C38 to near C40 to near C14 and back to near C16 again. The electrons 26 in the electron cooling system 14A that overlap the tritium ions 22B leave the electron source 24 near position C10, are guided by fields produced in solenoidal wire windings 30, and further are guided and bent by fields produced in the torroidal wire windings 32 so that they pass first near position C12, then near position C14, then near position C16, then near position C18, until they are finally collected then near position C20. The electrons 26 in the system 14B (14B is depicted below the system 14A) follow similar trajectories to the system in 14A.

Any number of storage rings (D, E, F, etc.) could be added, and the relevant point is that every other storage ring should contain deuterium ions 22A, with the remainder containing tritium ions 22B. (Storage ring A will always contain deuterium ions 22A. Storage ring B will contain tritium ions 22B if there are an even number of intersecting storage rings, and it will contain deuterium ions 22A if there are an odd number of intersecting storage rings.) The added storage rings (D, E, F, etc.) would have a configuration identical to storage ring C.

As seen in FIG. 1 and FIG. 2 the direction of ion 22 motion is counter clockwise within each storage ring. Significantly, where any two storage rings overlap the ion beams 22 are moving in opposing directions. Hence the ions 22 are brought into collision in the overlapping region.

By arranging for the appropriate ion 22 energies the reaction probability will be near optimal, with all collisions occurring at an energy that is close to the optimum energy for fusion reactions to occur. The ion 22 energies are initially established by the voltages present in the ion source 20, and are later affected by the electron cooling and space charge forces within the system 10. The center of momentum will be arranged to be close to the maximum of the fusion reaction cross section. However, due to electron scattering off of residual ions, it is advisable for the deuterium-tritium case that the energy be somewhat higher than the energy at the peak of the cross section. For the preferred embodiment described herein, the deuterium 22A beam will have an energy of about 240 keV in the interaction transport system 18 while the tritium 22B beam will have an energy of about 160 keV. This choice of energies results in a center of mass energy of about 400 keV, which is above the peak of the fusion energy cross section, but where the fusion interaction cross section is still high. (The peak of the cross section is about 5 barn and occurs at a center of mass energy of about 100 keV. At 400 keV the cross section is about 0.85 barn. A better device operation would likely be obtained by lowering the beam energies somewhat below 400 keV, but above the 100 keV where the electron scattering is a problem.) A significant advance of this invention is that it arranges almost all colliding particles 22 to have an energy close to what is desired for fusion reactions to occur, since conventional approaches such as tokamaks, inertial confinement, and sonic implosion involve fusable particles that have a thermal distribution wherein only a relatively small percentage of the particles have the appropriate energy for fusion to occur.

Not only does the invention arrange for the ions 22 to have the optimum energy for fusion reactions to occur, but the invention also arranges for the ions 22 to be focused to a very small area at interaction regions within the overlap portion of the interaction transport system 18. The invention achieves this condition through the use of dipole magnets 40, quadrupole magnets 38, and solenoidal magnets 36 each with an advantageous magnetic field configuration, and with each situated at advantageous positions. By focusing the ions 22 into a very small area, the number of collisions will be maximized, resulting in the maximum fusion output power.

### Component Specifications for a Preferred Embodiment

Component specifications for a preferred embodiment will now be presented. It should be understood that what follows is one concrete example of a preferred embodiment using specific values but that the specific values listed below are meant only as approximate values. FIG. 1 and FIG. 2 likewise represent two specific arrangements of the invention. Obviously, the invention could be embodied in a wide variety of shapes and sizes.

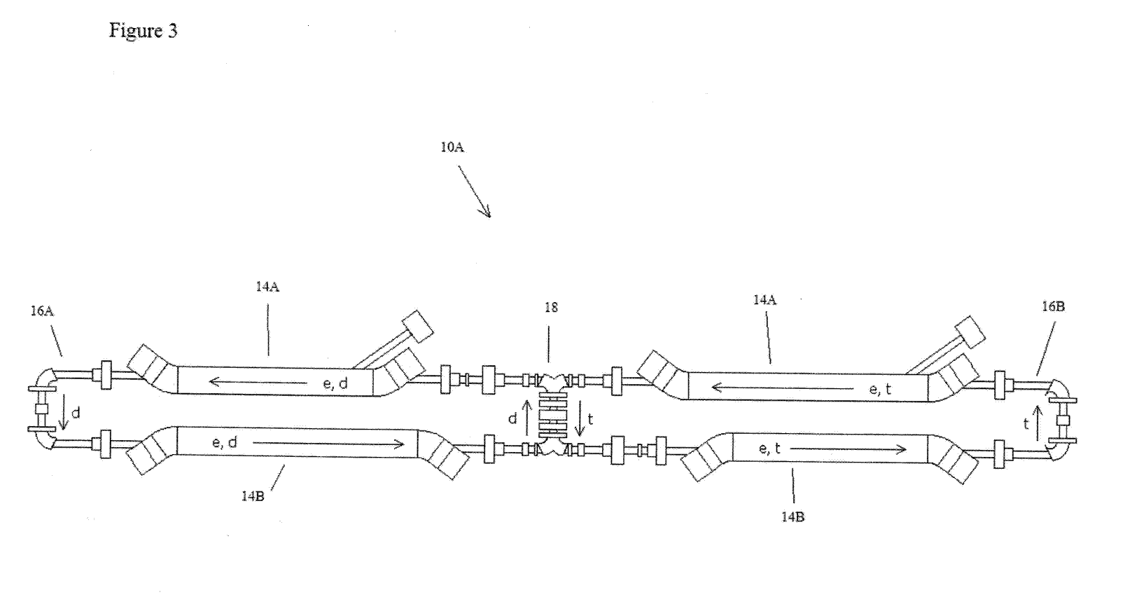

FIG. 3 depicts the same electron-cooled intersecting storage ring system 10A employing two intersecting storage rings as shown in FIG. 1, except that FIG. 3 identifies sub-systems of the system. It is seen that each storage ring consists of: 1) an electron cooling system 14A capable of cooling ions 22 and allowing ion 22 beam injection; 2) an end transport system 16 capable of transporting the ions 22 between two electron cooling systems 14; 3) an electron cooling system 14B capable of cooling ions 22; and 4) an interaction transport system 18 that allows overlapping transport of the ions 22 of two adjacent storage rings and providing focusing to enhance fusion reactions.

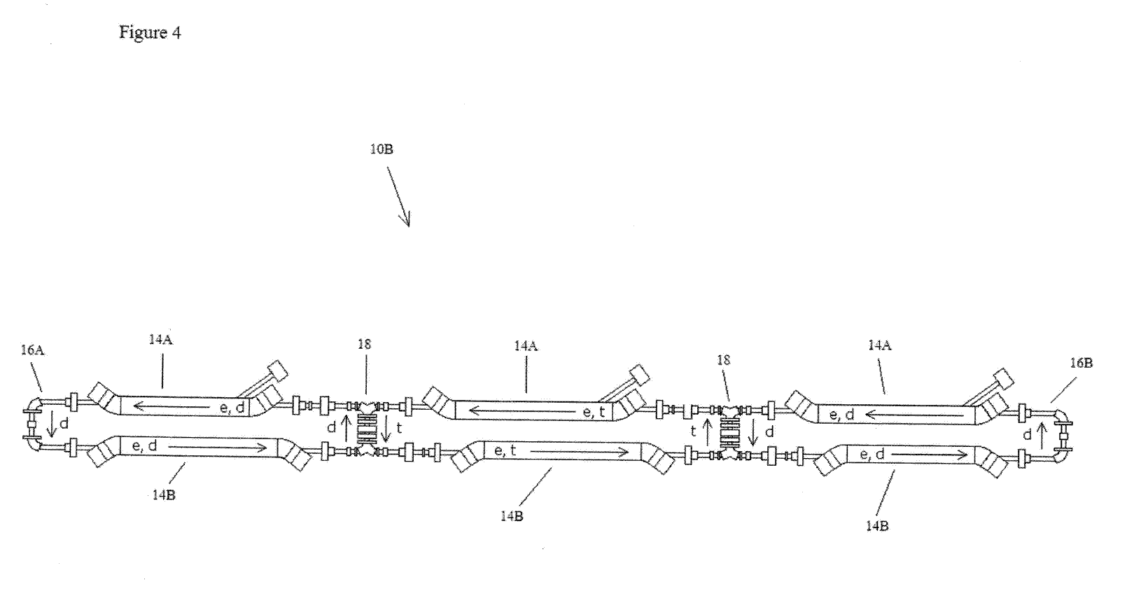

FIG. 4 depicts the same electron-cooled intersecting storage ring system 10B employing three intersecting storage rings as shown in FIG. 2, except that FIG. 4 identifies sub-systems of the system. In FIG. 4 it is seen that the interior storage ring consists of 1) an electron cooling system 14A capable of cooling ions 22 and allowing ion 22 beam injection; 2) an electron cooling system 14B capable of cooling ions 22; and 3) two interaction transport systems 18 that allow overlapping transport of the ions 22 of two adjacent storage rings and providing focusing to enhance fusion reactions.

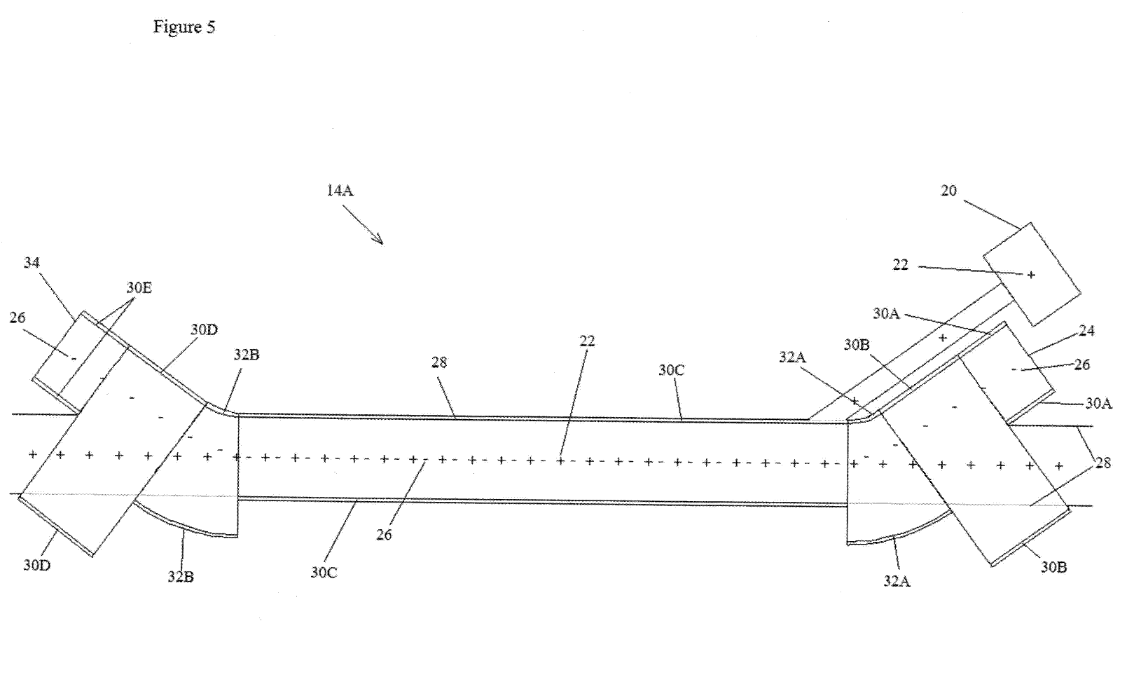

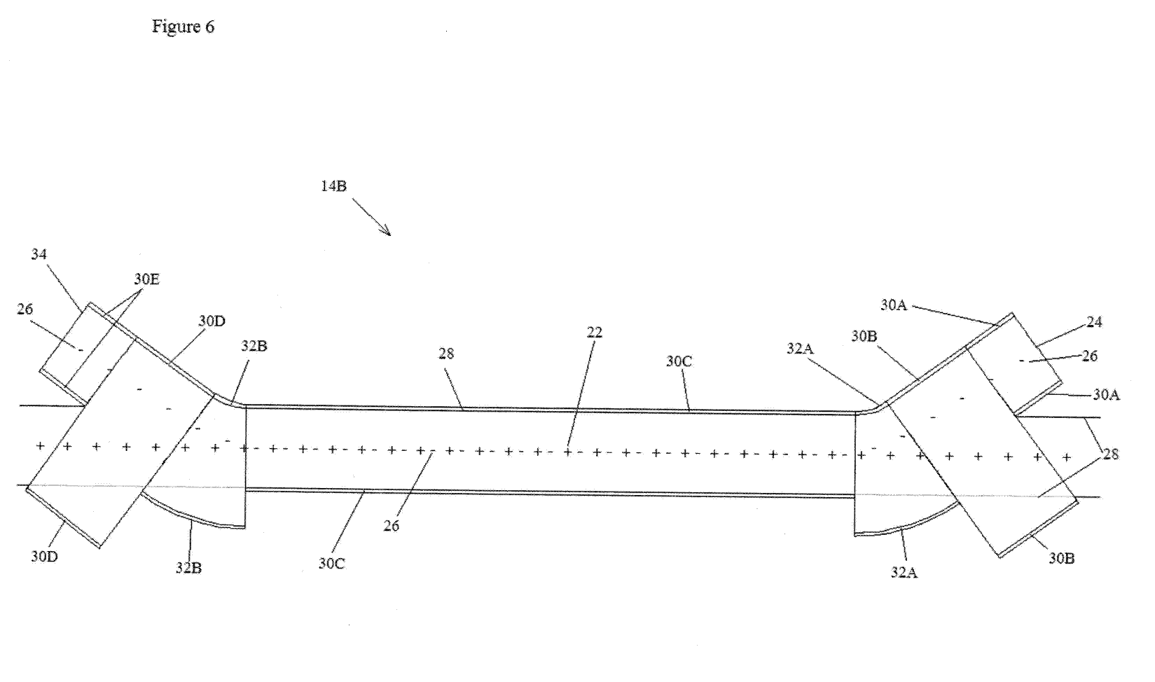

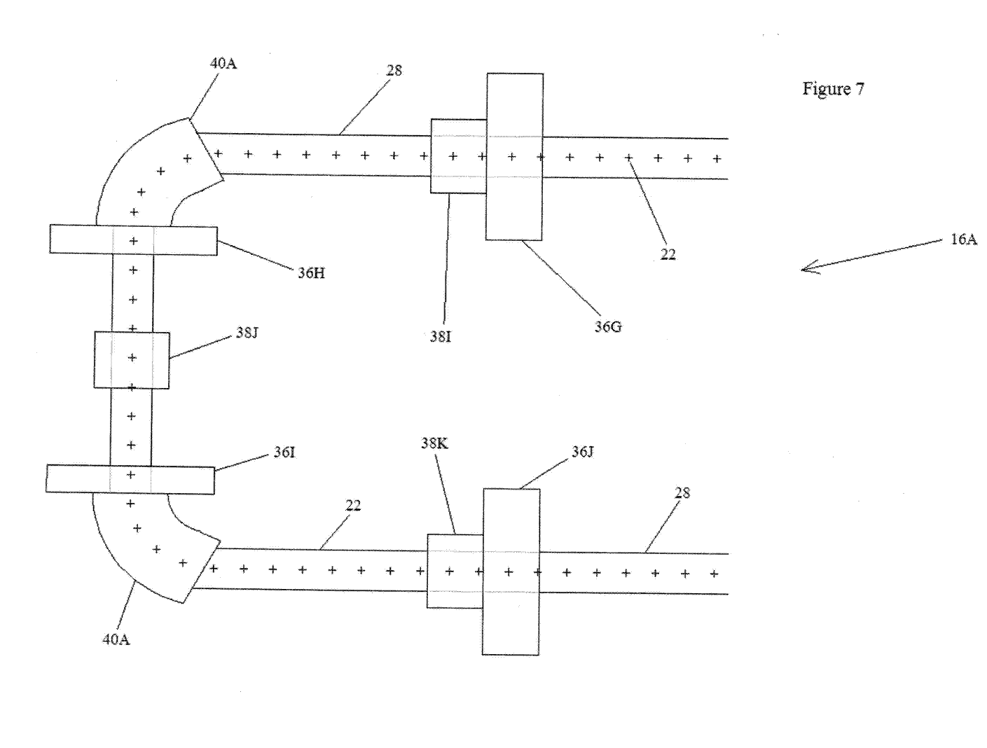

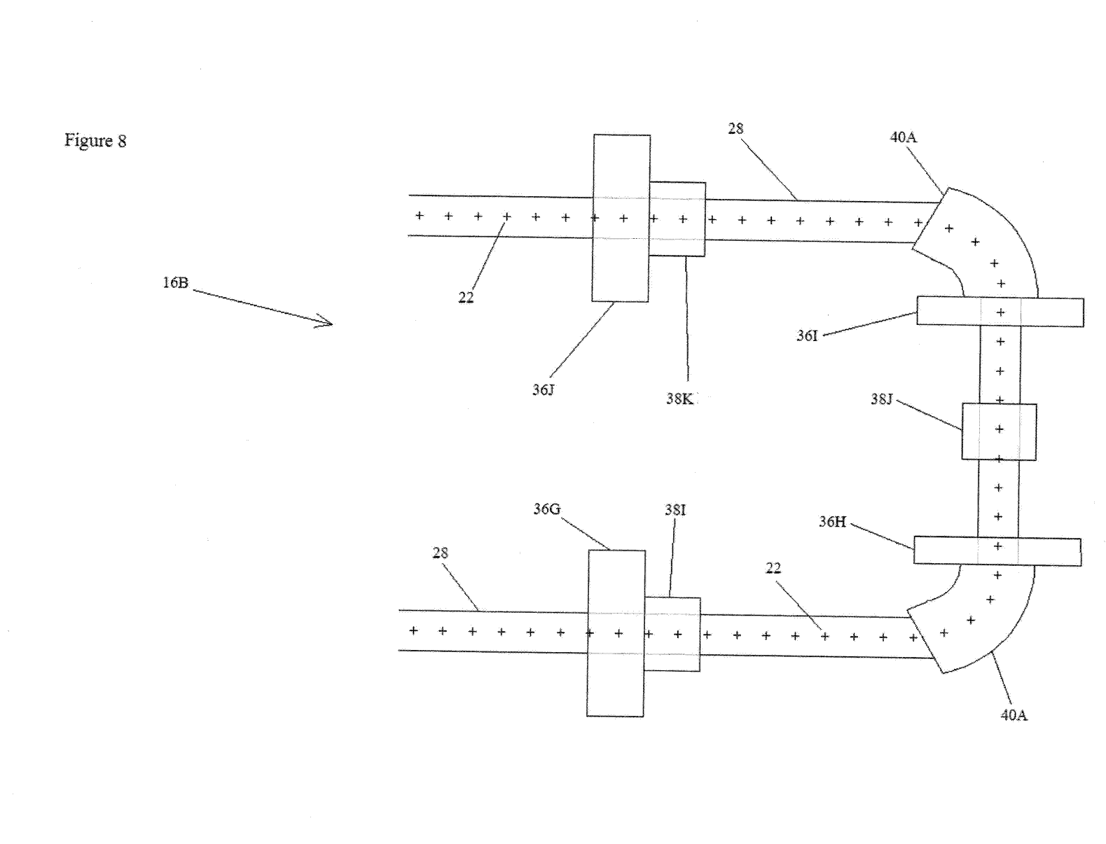

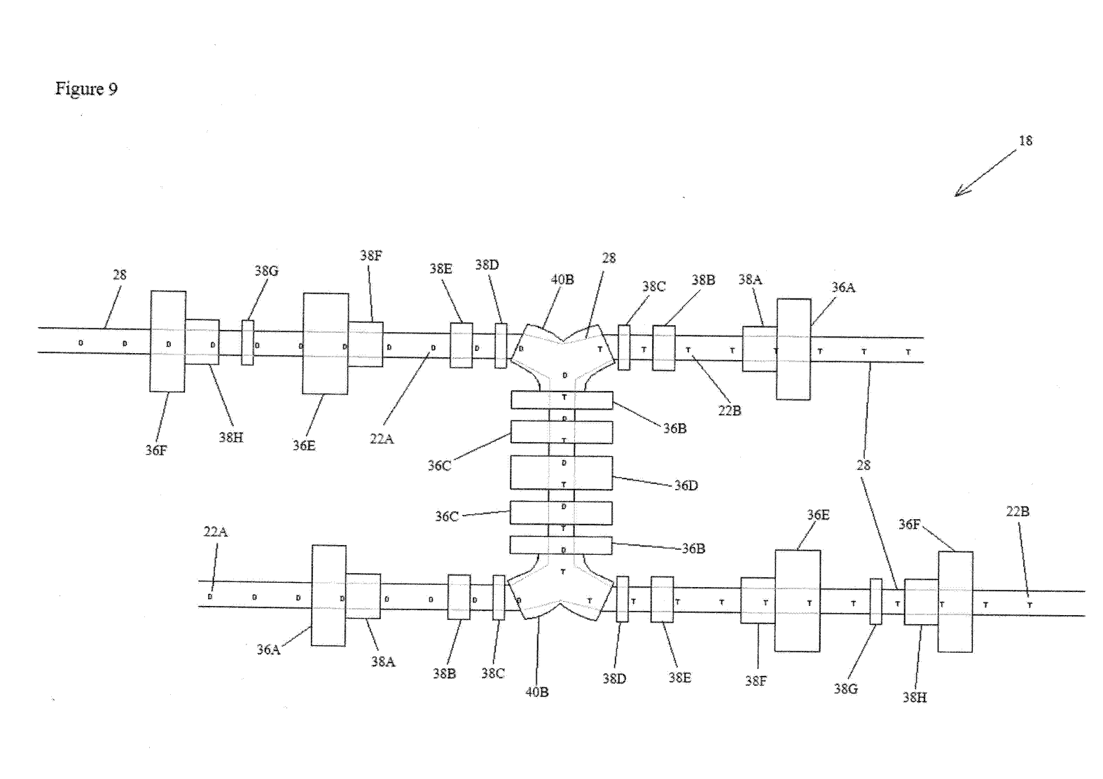

The sub-systems are depicted in FIG. 5, FIG. 6, FIG. 7, FIG. 8 and FIG. 9. FIG. 5 depicts the electron cooling system 14A, FIG. 6 depicts the electron cooling system 14B, FIG. 7 depicts the end transport system 16A, FIG. 8 depicts the end transport system 16B and FIG. 9 depicts the interaction transport system 18. Individual components are indicated on each of the sub-system depictions, and the component specifications for the preferred embodiment will now be described.

Table 1 presents a listing of the magnetic configurations used in the interaction transport system 18 of the preferred embodiment, while Listing 1 gives the nominal and approximate lengths of the components used in the interaction transport system 18.

Table 2 presents a listing of the magnetic configurations used in the end transport system 16 of the preferred embodiment, while Listing 2 gives the nominal lengths of the components used in the end transport system 16.

The electron cooling system 14 of the preferred embodiment includes a solenoid winding 30A surrounding the electron source 24, torroidal wire windings 32A and solenoidal wire windings 30B to merge the electron 26 beam with the ion 22 beam, a long solenoid winding 30C in the electron cooling region, torroidal wire windings 32B and solenoidal wire windings 30D to separate the electron 26 and ion 22 beams, and a solenoid winding 30E surrounding the electron collector 34. The central magnetic field within all of the solenoidal wire windings 30 and torroidal wire windings 32 of the electron cooling system 14 will be 100 Gauss in the preferred embodiment. The length in the beam direction of the long solenoid wire windings 30C will be about 14 meters to perform the cooling function and can be longer to arrange for proper joining of the subsystems. The radius of curvature in the electron 26 beam center within the torroidal wire windings 32 is one meter and the angular deflection of the electron 26 beam center within the torroidal wire windings 32 is 45 degrees in the preferred embodiment.

FIG. 5 shows an ion 22 injection system that injects ions 22 at a large angle, and does so in order to clearly show the concept of the invention. In a preferred embodiment, the angle of ion 22 injection will be much smaller. A smaller injection angle can be obtained either by having the injection line be in the plane perpendicular to the plane of the drawing, or by including a small dipole magnet 40 at the end of the ion 22 injection line.

### Listing 1. Elements Used in the Interaction Transport System 18.

Element 1—a 30 cm long magnetic solenoid, 36A.
Element 2—a 30 cm long magnetic quadrupole, 38A.
Element 3—a 60 cm long drift.
Element 4—a 20 cm long magnetic quadrupole, 38B.
Element 5—a 20 cm long drift.
Element 6—a 10 cm long magnetic quadrupole, 38C.
Element 7—a 10 cm long drift.
Element 8—a 62.832 cm central arc length dipole, 40B, with bending radius of 40 cm, (90 degree bend, arc length=[π/2]r) full gap of 25.4 cm, an entrance angle on the pole piece of −30 degrees, and zero angle on the exit pole piece.
Element 9—a 12.8 kV deceleration due to self space charge fields.
Element 10—a 15 cm long solenoid, 36B.
Element 11—an 11.21 cm long drift.
Element 12—a 20 cm long solenoid, 36C.
Element 13—an 11.21 cm long drift.
Element 14—a 30 cm long solenoid, 36D.
Element 15—an 11.21 cm long drift.
Element 16—a 20 cm long solenoid, 36C.
Element 17—an 11.21 cm long drift.
Element 18—a 15 cm long solenoid, 36B.
Element 19—a 12.8 kV acceleration due to self space charge fields.
Element 20—a 62.832 cm central arc length dipole, 40B, with bending radius of 40 cm, (90 degree bend, arc length=[π/2]r) full gap of 25.4 cm, an entrance angle on the pole piece of 0 degrees, and a −30 degree angle on the exit pole piece.
Element 21—a 10 cm long drift.
Element 22—a 10 cm long magnetic quadrupole, 38D.
Element 23—a 20 cm long drift.
Element 24—a 20 cm long magnetic quadrupole, 38E.
Element 25—a 60 cm long drift.
Element 26—a 30 cm long magnetic quadrupole, 38F.
Element 27—a 40 cm long solenoid, 36E.
Element 28—a 45 cm long drift.
Element 29—a 10 cm long magnetic quadrupole, 38G.
Element 30—a 20 cm long drift.
Element 31—a 30 cm long magnetic quadrupole, 38H.
Element 32—a 30 cm long solenoid, 36F.

TABLE 1
Magnetic Excitations of Solenoids 36 and Quadrupoles 38 For Various
Conditions Within the Interaction Transport System 18.

| | Deuterium, | | Deuterium, | | Deuterium, | | Tritium, | | Tritium | |
|---|---|---|---|---|---|---|---|---|---|---|
| Element | full current | | half current | | no current | | full current | | no current | |
| 36A | 2.19 | kG | 2.60 | kG | 2.95 | kG | 2.18 | kG | 3.00 | kG |
| 38A | −6.40 | G/cm | −9.07 | G/cm | −12.2 | G/cm | −6.74 | G/cm | −12.1 | G/cm |
| 38B | 27.7 | G/cm | 45.8 | G/cm | 82.5 | G/cm | 32.4 | G/cm | 81.6 | G/cm |
| 38C | −251 | G/cm | −205 | G/cm | −322 | G/cm | −278 | G/cm | −324 | G/cm |
| 36B | 10 | kG | 10.5 | kG | 11 | kG | 10 | kG | 11 | kG |
| 36C | 6 | kG | 6 | kG | 6 | kG | 6 | kG | 6 | kG |
| 36D | 10 | kG | 10 | kG | 10 | kG | 10 | kG | 10 | kG |
| 36C | 6 | kG | 6 | kG | 6 | kG | 6 | kG | 6 | kG |
| 36B | 10 | kG | 10.5 | kG | 11 | kG | 10 | kG | 11 | kG |
| 38D | −299 | G/cm | −187 | G/cm | −355 | G/cm | −210 | G/cm | −333 | G/cm |
| 38E | 29.3 | G/cm | 38.2 | G/cm | 82.9 | G/cm | 13.9 | G/cm | 80.2 | G/cm |
| 38F | −6.35 | G/cm | −9.07 | G/cm | −12.2 | G/cm | −6.74 | G/cm | −12.1 | G/cm |
| 36E | 4.45 | kG | 4.67 | kG | 4.94 | kG | 4.30 | kG | 5.02 | kG |
| 38G | 2.06 | kG/cm | 2.06 | kG/cm | 2.06 | kG/cm | 1.56 | kG/cm | 1.56 | kG/cm |
| 38H | −2.97 | G/cm | −2.02 | G/cm | −2.76 | G/cm | 0.1 | G/cm | −2.02 | G/cm |
| 36F | 4.36 | kG | 4.50 | kG | 4.63 | kG | 4.37 | kG | 4.69 | kG |

### Listing 2. Elements Used in the End Transport System 16.

Element 1—a 30 cm long magnetic solenoid, 36G.

Element 2—a 30 cm long magnetic quadrupole, 38I.
Element 3—a 120 cm long drift.
Element 4—a 62.832 cm central arc length dipole, 40A, with bending radius of 40 cm, (90 degree bend, arc length=[π/2]r) full gap of 25.4 cm, an entrance angle on the pole piece of −30 degrees, and zero angle on the exit pole piece.
Element 5—a 15 cm long magnetic solenoid, 36H.
Element 6—a 42.42 cm long drift.
Element 7—a 30 cm long magnetic quadrupole, 38J.
Element 8—a 42.42 cm long drift.
Element 9—a 15 cm long magnetic solenoid, 36I.
Element 10—a 62.832 cm central arc length dipole, 40A, with bending radius of 40 cm, (90 degree bend, arc length=[π/2]r) full gap of 25.4 cm, an entrance angle on the pole piece of 0 degrees, and a −30 degree angle on the exit pole piece.
Element 11—a 120 cm long drift.
Element 12—a 30 cm long magnetic quadrupole, 38K.
Element 13—a 30 cm long magnetic solenoid, 36J.

TABLE 2
Magnetic Excitations For Various Conditions in the End Transfer
System 16.

| | Deuterium, | | Deuterium, | | Tritium, | | Tritium | |
|---|---|---|---|---|---|---|---|---|
| Element | full current | | no current | | full current | | No current | |
| 36G | 2.15 | kG | 3.0 | kG | 2.2 | kG | 3.0 | kG |
| 38I | 2.57 | G/cm | 2.57 | G/cm | 2.60 | G/cm | 2.60 | G/cm |
| 36H | 9.79 | kG | 10.83 | kG | 9.93 | kG | 11.14 | kG |
| 38J | 130 | G/cm | 204 | G/cm | 134 | G/cm | 209 | G/cm |
| 36I | 9.79 | kG | 10.83 | kG | 9.93 | kG | 11.14 | kG |
| 38K | 1.69 | G/cm | 2.34 | G/cm | 1.78 | G/cm | 2.40 | G/cm |
| 36J | 2.11 | kG | 2.99 | kG | 2.16 | kG | 2.99 | kG |

### Operational Calculations: Expected Power Output

The power output from fusion reactions can be calculated from Eq. (3):

Power Output=1.90×10⁻²⁷(1+v_{D}/v_{T})(LI_{T}I_{D}/ev_{D}πr²)m²MV. (3)

Parameters used in the preferred embodiment are a length of the region where the beams are small of L=1.2 mm, a deuterium 22A beam current of I_{D}=10,000 A, a tritium 22B beam current of I_{T}=10,000 A, and a radius of the beams where they are small within the interaction transport system 18 of r=90 μm. For these parameters the density of deuterons 22A within the small interaction volume is n_{D}=5.12×10¹⁷ cm⁻³, the density of tritons 22B within the small interaction volume is n_{T}=7.66×10¹⁷ cm⁻³ and the power output from one small interaction volume is 29.2 kW. For the preferred embodiment, there are two small interaction volumes in each interaction transport system 18, and hence the power output will be 58.4 kW per interaction transport system 18 of the preferred embodiment.

(Note that in the above expression it is assumed that r will be constant, when in fact it will vary considerably over the interaction region. In actuality, the power output will be 2.24×10⁻²⁷(1+v_{D}/v_{T})(I_{T}I_{D}/ev_{D}π)m²MV ∫dx/[a(x)b(x)], where dx is the differential unit of measure in the beam direction, a(x) is the beam horizontal size and b(x) is the beam vertical size. The integral is to be evaluated throughout the region where the beams collide. For the preferred embodiment, the quantity ∫dx/[a(x)b(x)]=139,000 m⁻¹, while the approximation L/r²148,000 m⁻¹. Hence, it is a good approximation to use L=1.2 mm and r=90 microns when evaluating the power output.)

### Operational Calculations: Beam Neutralization

If there were no compensating factor, the electric self charge of 10,000 A tritium 22B beam currents at an energy of 160 keV would be too large to sustain the beam. A formula to estimate the beam center to beam edge electric potential is V=30I/β, where I is in Amperes, β is the beam velocity divided by the speed of light, and V is in volts. For 160 keV tritium 22B beams, β=0.0107, and with I=10,000 A this leaves a beam center to beam edge potential difference of 28 MegaVolts, about 175 times greater than the tritium 22B beam energy itself. Clearly, such a condition cannot be established. Nonetheless, it is possible to arrange for 10,000 Ampere beams at 160 keV, due to the trapping of free electrons within the beam. Electrons will be formed from the ionization of background gasses and they will be trapped by any electrostatic potential that is greater than their own kinetic energy. Calculations have shown that an equilibrium situation is obtained when an electrostatic potential of 5625 Volts is established between the beam edge and the beam center in the interaction region. In the non-interaction regions, the equilibrium is established at about 228 V for the tritium 22B case, and 390 V for the deuterium 22A case. In the region where the electron 26 beam overlaps the ion 22 beam, the neutralization occurs due to similar currents of oppositely charged particles. In the regions where the electrons 26 flow without overlapping ion 22 beams, residual ions will neutralize the electron 26 beam.

### Operational Calculations: Halo Formation and Control

As just described, background particles will lead to electric field neutralization that will greatly reduce the self space charge electric fields of the particle beams used in the invention. However, some electric field will remain, as it is this remnant electric field that serves to contain the neutralizing particles. This electric field will manifest itself toward the outer regions of the particle beams, since it is the nature of plasmas (or any conductor) that residual charge migrates toward the outside. The presence of this electric field will lead to the formation of a portion of the beam that has a different ion 22 optical profile than the main core beam. This new profile is called “beam halo” since it is a faint amount of the beam that exists outside of the main beam at focal points. Advantageously, the invention uses magnets to focus this beam halo where the main core beam is small. This technique allows for independent focusing of the beam halo from the core beam, and is used to retain the beam halo particles in the system. While the beam halo must be cooled to return it to the main beam, the energy expended in cooling the beam halo is far less than what would be expended if the beam halo were lost from the system entirely and had to be replaced by additional injected beam.

### Operational Calculations: Self Magnetic Field Limitation on Currents

It can be seen from Eq. (3) that the output fusion power scales as the deuterium 22A current multiplied by the tritium 22B current, among other factors. Hence it is advisable to maximize the beam currents within the device. However, Table 1 and 2 show that the magnetic fields employed in the components are already significantly affected by the design currents of 10,000 A and therefore the design current is appropriate for the analysis of the preferred embodiment. The invention advantageously uses tunable magnetic components to operate over a range of beam current conditions, allowing the invention to operate from the low initial startup beam currents all the way up to the full design current.

### Operational Calculations: Beam Energy Losses

As particle beams traverse matter they lose energy via the dE/dx process. The rate of energy loss is given by the following formula:

dE/dx=[ωₚ²z²e²/v²] ln(Λv/ωₚbₘᵢₙ) (4)

In Eq. (4) Λ is a factor of order unity (and therefore not important since it is within the logarithm), bₘᵢₙ is the larger of either ze²/γmv² or /γmv, and ωₚ²=4πne²/m=4πnc²rₑ. Here n is the number of electrons per unit volume, and rₑ is the classical radius of the electron, rₑ=2.82×10⁻¹³ cm, e is the charge on the electron, m is the mass of the electron, c is the speed of light, v is the velocity of the ions 22 with respect to the matter being traversed, and z is the charge of the nuclei of the matter being traversed. γ is a relativistic factor that can be set equal to one here.

The particle beams 22 will lose energy via Eq. (4) to background gas particles in the vacuum chamber 28 as well as to electrons trapped by the Coulomb potential within the beams. The dE/dx mechanism will in turn heat the background gas particles and trapped electrons. A detailed analysis has been done to calculate the expected dE/dx energy loss, with the results given in Table 3 below.

TABLE 3
dE/dx Power Losses.

| Parameter | Value | |
|---|---|---|
| dE/dx Power Loss in One Interaction Region | 750 | W |
| dE/dx Power Loss in Tritium Non-Interaction | 22 | W |
| Region | | |
| dE/dx Power Loss in Deuterium Non-Interaction | 12 | W |
| Region | | |
| Deuterium dE/dx Power Loss to Background | 31.5 | W |
| Gas | | |
| Tritium dE/dx Power Loss to Background Gas | 17.5 | W |
| dE/dx Power Electron Cooling Beam Loses to | 193 | W |
| Background Gas, Deuterium Case | | |
| dE/dx Power Electron Cooling Beam Loses to | 87.4 | W |
| Background Gas, Tritium Case | | |
| Energy Supplied by Electrons to Overcome Ion | 0.094 | eV |
| dE/dx Losses, Tritium Case | | |
| Energy Supplied by Electrons to Overcome Ion | 0.0644 | eV |
| dE/dx Losses, Deuterium Case | | |

### Operational Calculations: Intrabeam Scattering, Single Scattering, Multiple Scattering, Recombination and Charge Exchange

Many scattering processes will exist within the storage ring system. The particles can scatter off of an oncoming beam, off of residual gas particles in the vacuum chamber 28, off of charged neutralizing particles trapped by the Coulomb forces within the beams, and off of other particles within the same beam. These effects have been calculated in detail, with the important results summarized in Tables 4, 5, and 6.

TABLE 4
Single Scattering Parameters.

| Parameter | | Value |
|---|---|---|
| Single Scattering Angle Presumed Lost | | 0.2 rad |
| Cross Section for Single Scattering Loss | | 10.11 barn |
| Single Scattering off of Residual Gas | | Negligible |
| Single Scattering Effective Beam Emittance | ε_{scat} | 8.68 × 10⁻⁸π |
| Single Scattering Beam Size in Cooler | | 38.8 cm |
| (Deuterium) | | |
| Single Scattering Beam Size in Cooler | | 39.5 cm |
| (Tritium) | | |
| Electrons that Scatter off Residual Ions at >0.1 | | 4.7% per meter |
| radians, Tritium Cooling Case | | |
| Electrons that Scatter off Residual Ions at >0.1 | | 0.66% per meter |
| radians, Deuterium Cooling Case | | |
| Single Scattering of Electron Beams off | | Negligible |
| Background Gas | | |
| Heating of Electron Beam due to Ion Single | | Negligible |
| Scattering | | |

TABLE 5
Multiple Scattering Parameters.

| Parameter | | Value |
|---|---|---|
| Multiple Beam-Beam Scattering Emittance | Δε_{nT} | 6.65 × 10⁻⁹π m-r |
| Growth of the Tritium Beam (One Interaction | | |
| Waist) | | |
| Multiple Beam-Beam Scattering Emittance | Δε_{nD} | 9.95 × 10⁻⁹π m-r |
| Growth of the Deuterium Beam (One | | |
| Interaction Waist) | | |
| Ion Multiple Scattering off of Residual Gas | | Negligible |
| Multiple Scattering of Electron Beams off | | Negligible |
| Background Gas | | |
| Heating of Electron Beam due to Ion Multiple | | Negligible |
| Scattering | | |
| Electron Multiple Scattering Emittance Growth | | 20% |
| due to Residual Ions in 10 cm, tritium case | | |
| Electron Multiple Scattering Emittance Growth | | 7.3% |
| due to Residual Ions in 10 cm, deuterium case | | |

TABLE 6
Intrabeam Scattering Parameters.

| Parameter | | Value |
|---|---|---|
| Deuterium Longitudinal Intrabeam Scattering | Δdp/p | 4.2 × 10⁻⁴ |
| Growth (per turn, two interaction Waists) | | |
| Tritium Longitudinal Intrabeam Scattering Growth | Δdp/p | 9.8 × 10⁻⁴ |
| (per turn, two interaction Waists) | | |
| Electron Heating Due to Intrabeam Scattering of | ΔEᵢₒₙ | 0.39 eV |
| Tritium | | |
| Electron Heating Due to Intrabeam Scattering of | ΔEᵢₒₙ | 0.19 eV |
| Deuterium | | |
| Growth in Electron Cooling Beam Radius Due to | | 2.04 mm |
| Transverse Self Scattering | | |
| Growth in Electron Cooling Beam Momentum | | Negligible |
| Spread Due to Longitudinal Self Scattering | | |

### Operational Calculations: Recombination and Charge Exchange

Recombination of the free hydrogen ions 22 with the free electrons present in the system will result in a neutral hydrogen atom. Since the newly formed atom is now in an uncharged state, it will no longer be bound by the magnetic confinement fields and can therefore be lost. Generally this effect is considered too small to be considered in electron cooling experiments, as the loss rate is usually on the order of tens of particles per second. For the invention discussed herein, the expected loss rate will be about 2.6×10⁻¹² A, which is negligibly small.

As the ions 22 traverse through the neutral gas atoms in the vacuum chamber 28 an electron can be exchanged from the gas atom to the ion 22 in the beam. This potential loss mechanism has been estimated to have an upper bound of 10 kW for the invention.

### Operational Calculations: Plasma Instabilities

Plasma instabilities are important considerations for most hot fusion devices. An important number in this regard is the number of plasma oscillations that will occur within the system per unit time, which is related to the plasma frequency, ωₚ²=4πne²/m, where n is the number of electrons per unit volume, e is the charge of the electron, and m is the mass of the electron. For the invention described herein, the number of plasma oscillations that occur in various regions are summarized in Table 7. As can be seen from the table, about 29,000 plasma oscillations will take place during the passage of a tritium ion 22B through one half cell of the invention, and 18,200 plasma oscillations will take place during the passage of a deuterium ion 22A through one half cell of the invention.

TABLE 7
Number of Plasma Oscillations Within the System.

| Parameter | Number |
|---|---|
| Number of Plasma Oscillations During Deuteron | 5080 |
| Transit of the Interaction Region | |
| Number of Plasma Oscillations During Triton | 7600 |
| Transit of the Interaction Region | |
| Number of Plasma Oscillations During Deuteron | 5500 |
| Transit of the Cooling Region | |
| Number of Plasma Oscillations During Triton | 9970 |
| Transit of the Cooling Region | |
| Number of Plasma Oscillations During Deuteron | 7620 |
| Transit of the Remaining Regions | |
| Number of Plasma Oscillations During Triton | 11400 |
| Transit of the Remaining Regions | |

Direct excitation of the resonant electron oscillations at ωₚ will not appear as there will be no electron cyclotron resonant power source in the invention.

The Buneman instability (two stream instability) and various classes of the beam-plasma instabilities should not exist in the invention. The Buneman instability manifests itself in situations where the drift velocity is greater than the electron thermal velocity, and that condition is not present in the invention, since the dE/dx mechanism will quickly heat the plasma electrons to velocities in excess of the ion 22 beam drift velocities. The beam-plasma instability also relies on an interaction between plasma oscillations in the beam and the plasma. In the case of the invention, the temperature of the electron plasma is so high that the thermal motion of the electrons will cause such incoherence in the electron plasma that these instabilities can not grow.

The resonant condition for ion motion occurs at the frequency ωᵢ=(m/Mᵢ)^{1/2}ωₚ. For tritons 22B, the square root of the mass ratio is (m/M_{T})^{1/2}=1/74, and therefore the number of natural ion 22B oscillations that will take place during the triton's 22B passage through an invention cell is about 390. For deuterons 22A, the square root of the mass ratio is (m/M_{D})^{1/2}=1/61, and therefore the number of natural ion 22A oscillations that will take place during the deuteron's 22A passage through an invention cell is about 300. These times are too short for most plasma oscillations to present a problem for the invention considered herein. This is because the beam ions 22 are continuously passing through electrons and the oncoming ion 22 beams at different physical locations during even this short time. Hence, it should not be possible for oscillations to set up a positive feedback to beam density disturbances, and this is the root cause of plasma instabilities. With the root cause of plasma instabilities not present within the extremely short time scale of the interaction, no destructive plasma instabilities should occur.

Any small beam density disturbance that does get started in a single pass through the invention cell will be eliminated during the passage through the electron cooling system 14. The electrons 26 within the electron cooling system 14 are born anew (at the cathode of the electron source 24) continuously, and have no history of interaction with the ion 22 beams between subsequent passes. Hence, when the ions 22 come to equilibrium with the electrons 26 in the electron cooling system 14, they do so with electrons 26 that have no correlation with electrons 26 on previous or subsequent turns.

Note that the invention cell is considerably different from a tokamak in its approach to fusion energy generation. In a tokamak, the ion-electron plasma must exist for time scales on the order of a second (or, eventually, much longer), various beams are used for heating, and there is a magnetic confining field. For the invention discussed herein, the ions 22 only exist in the individual interaction plasmas for less than a nanosecond, there are no external energy sources beyond the beam 22 self motion, and there is no containing solenoidal field for the ions 22. Therefore, many of the conditions required for plasma instabilities simply do not exist in the invention.

### Operational Calculations: Beam Instabilities and Resonances

In traditional storage rings instabilities arise because the large numbers of particles stored have a significant collective self space charge field. If a disturbance forms in the particle distribution, the field from the disturbance can affect the environment surrounding the beam, setting up oscillating electromagnetic fields. If those fields then act back on the space charge disturbance such that the disturbance grows, an instability exists which can destroy the beam.

Resonant phenomena are also usually important to evaluate. Resonances occur when some of the particles circulate the device in such a way as to be at the same transverse position at every (or every other) turn around the device. Those particles which exhibit this behavior will see the same magnet imperfections on every (or every other) pass, and will be quickly lost from the device.

In the invention described herein the problem of instability and resonant loss should not exist. The presence of strong electron cooling forces means that any small offset in particle momentum will be corrected on each pass. Cooling in a single turn means that the invention here is, from an accelerator physics standpoint, a single pass device, in which instabilities are known to be far less troublesome and in which resonances do not exist.

### Operational Calculations: Expected Power Input; Expected Q.

The scientific Q is defined as the output power divided by the power input supplied to the various beams used in the invention. It is calculated above that the power output of a single interaction region is 29.2 kW, and herein it assumed that there are two interaction regions per interaction transport system 18, which results in:

Predicted Output Power=58.4 kW per interaction transport system 18. (5)

The power input of the supplied tritium 22B and deuterium 22A beams is equal to the total energy supplied to these beams multiplied by the feed current required to keep the nominal beam currents at 10,000 A. The feed current must be equal to the ions 22 that are lost to fusion plus those that are lost to scattering. The fusion cross section is about 0.85 barn, while Table 4 specifies that the cross section for single scattering of the beams is about 10 barn. The remainder of Table 4 shows that other scattering processes have a negligible contribution to the particle loss rate. Also, the 0.85 barn fusion cross section is almost certainly contained within the 10 barn scattering cross section (as the 10 barn results from the nearest collisions, which are also those most likely to result in fusion). Hence, the feed current required is 10/0.85 times that which would result in the output power of 58.4 kW, or, (10×58.4 kW)/(0.85×22.4 MV)=30.7 mA. The required power input of the tritium 22B beam is thus 30.7 mA×167 kV=5.1 kW, and the required power input of the deuterium 22A beam is 30.7 mA×247 kV=7.6 kW, leaving:

Required Ion 22 Beam Drive Power=12.7 kW. (6)

For a single electron 26 beam to provide the tritium 22B beam cooling, the beam energy that must be supplied is the sum of the energy lost, which is the 0.094 eV shown in Table 3 as the energy needed to overcome the dE/dx of the tritons 22B being cooled, plus 0.01 eV which is the energy needed to overcome the dE/dx loss of the electrons 26 to the residual gas, plus the energy spread induced by the need to cool the intrabeam scattering, shown in Table 6 as 0.39 eV, all multiplied by 10,000 A:

Tritium 22B cooling electron 26 beam drive power:4.94 kW (7)

For a single electron 26 beam to provide the deuterium 22A beam cooling, the beam energy that must be supplied is the sum of the energy lost, which is the 0.0644 eV shown in Table 3 as the energy needed to overcome the dE/dx of the deuterons 22A being cooled, plus 0.02 eV which is the energy needed to overcome the dE/dx loss of the electrons 26 to the residual gas, plus the energy spread induced by the need to cool the intrabeam scattering, shown in Table 6 as 0.19 eV, all multiplied by 10,000 A:

Deuterium 22A cooling electron 26 beam drive power:2.744 kW (8)

Eqs. (5) through (8) leave the predicted scientific Q value as:
e

Q scientific=58.4/(12.7+4.94+2.744)+1=2.86+1=3.86. (9)

In Eq. (9) the addition of 1 to the ratio comes from the realization that the lost ion 22 and electron 26 power will also generate heat and contribute to the overall output power. Obtaining a Q value this high will enable the invention to perform as a power source for generating electricity.

### Other Preferred Embodiments

The above preferred embodiment concerns use of the invention to achieve colliding beam fusion of deuterium 22A and tritium 22B with a center of mass energy of about 400 keV. The analysis indicates that gains can be made by lowering the center of mass energy. Also, the invention can be used with other ion combinations, including deuterium colliding with Helium-3, deuterium-deuterium, proton-Lithium-6 and proton-Boron-11 among others. The peak of the cross section occurs within operating ranges for these reactions of: 50 keV to 500 keV for deuterium-tritium; 200 keV to one MeV for deuterium-helium-3; and one MeV to four MeV for deuterium-deuterium. For the lower energies in this range, a simple ion source can be used for particle beam generation while for the higher energies an ion source and an injector accelerator could be used. Scattering losses, beam energy losses, and beam sourcing powers must be considered in detail before choosing an optimum operating point, but it is expected that the invention would optimally operate somewhere in these ranges for those species.

What is claimed is:

1. A nuclear fusion reaction and intersecting particle storage ring system for enabling nuclear fusion reactions comprising:
a projectile particle supply device to supply a plurality of projectile particles;
a plurality of intersecting storage rings that receive projectile particles from said projectile particle supply wherein said projectile particles circulate within said intersecting storage rings;
an overlap section within each of said intersecting storage rings that overlaps a section of another said intersecting storage ring wherein said nuclear fusion reactions occur; and
an electron subsystem having an electron source that introduces electrons into one said intersecting storage ring and having an electron collector that captures said electrons.

2. A system in accordance with claim 1, wherein said projectile particle supply device substantially continuously supplies projectile particles to said intersecting storage rings.

3. A system in accordance with claim 1, wherein said projectile particle supply device includes an ion source.

4. A system in accordance with claim 1, wherein said projectile particle supply device includes an ion source and an injector accelerator.

5. A system in accordance with claim 1, wherein said plurality of intersecting storage rings includes:
a plurality of linear segments connected by a plurality of curved segments; and
a plurality of dipoles situated proximate to said curved segments to guide said projectile particles through said curved segments;
and
a plurality of quadrupoles and solenoids situated proximate to said linear segments to focus the projectile particles to small areas in order to enhance the rate of nuclear fusion reactions.

6. A system in accordance with claim 1, wherein said overlap section is situated in a linear segment of one of said storage ring.

7. A system in accordance with claim 1, wherein said overlap section is situated in a curved segment of one of said storage ring.

8. A system in accordance with claim 1, wherein each said electron system is situated in a linear segment of one of said storage ring.

9. A system in accordance with claim 1, further including merging and separating dipoles situated adjacent to said overlap region to guide one beam into said overlap region and guide one beam out of said overlap region.

10. A reaction and storage system for projectile particles, comprising:
a deuterium supply device and a tritium supply device;
a plurality of intersecting storage rings wherein every other intersecting storage ring receives deuterons from said deuterium supply device and the remaining intersecting storage rings receive tritons from said tritium supply device;
a first overlap section within each end said storage ring wherein said first overlap section overlaps a section of an adjacent said storage ring to bring deuterons into collision with tritons and wherein nuclear fusion reactions occur;
a second overlap section and a third overlap section within each non-end said storage ring wherein said second overlap section overlaps a section of an adjacent said storage ring to bring deuterons into collision with tritons and wherein nuclear fusion reactions occur and wherein said third overlap section overlaps a section of an adjacent said storage ring to bring deuterons into collision with tritons and wherein nuclear fusion reactions occur;
and
a plurality of electron subsystems that each introduce electrons into one of said intersecting storage rings and then remove and capture said electrons.

11. A system in accordance with claim 10, wherein said deuterium and tritium particle supplies include an ion source.

12. A system in accordance with claim 10, wherein said deuterium and tritium supplies include an ion source and an injector accelerator.

13. A system in accordance with claim 10, wherein each of said intersecting storage rings includes:
a plurality of linear segments connected by a plurality of curved segments; and
a plurality of dipoles situated proximate to said curved segments to guide said projectile particles through said curved segments;
and
a plurality of quadrupoles and solenoids situated proximate to said linear segments to focus the projectile particles to small areas in order to enhance the rate of deuteron-triton fusion reactions.

14. A system in accordance with claim 10, wherein said overlap sections are situated in a linear segment of said intersecting storage ring.

15. A system in accordance with claim 10, wherein each said electron subsystem includes an electron source, solenoidal windings, torroidal windings and an electron collector.

16. A system in accordance with claim 10, wherein the system further includes merging and separating dipoles situated adjacent to said overlap regions to guide a triton beam into said overlap region and guide a deuteron beam out of said overlap region.

17. A system in accordance with claim 10, further including merging and separating dipoles situated adjacent to said overlap region to guide a deuteron beam into said overlap region and guide a triton beam out of said overlap region.

18. A reaction and storage system, comprising:
a particle supply device to supply particles;
intersecting storage rings that receive the particles from said particle supply device;
a first overlap section within each end said storage ring wherein said first overlap section overlaps a section of an adjacent said storage ring to bring particles into collision and wherein nuclear fusion reactions occur;
a second overlap section and a third overlap section within each non-end said storage ring wherein said second overlap section overlaps a section of an adjacent said storage ring to bring particles into collision and wherein nuclear fusion reactions occur and wherein said third overlap section overlaps a section of an adjacent said storage ring to bring particles into collision and wherein nuclear fusion reactions occur;
and
a plurality of electron subsystems that each introduce electrons into one said storage ring and then remove and capture said electrons.

19. A system in accordance with claim 18, wherein all said particle supplies supply deuterium particles.

20. A system in accordance with claim 18, wherein every other said particle supply device supplies deuterium particles and each remaining said particle supply device supplies Helium-3 particles.

21. A system in accordance with claim 18, wherein every other said particle supply device supplies proton particles and each remaining said particle supply device supplies Lithium-6 particles.

22. A system in accordance with claim 18, wherein every other said particle supply device supplies proton particles and each remaining said particle supply device supply Boron-11 particles.

23. A system in accordance with claim 18, wherein said particle supply device includes an ion source.

24. A system in accordance with claim 18, wherein said particle supply device includes an ion source and an injector accelerator.
